(19) United States
(12) Patent Application Publication
(10) Pub. No.: US 2022/0024447 A1
(43) Pub. Date: Jan. 27, 2022

(54) TURNING CONTROL SYSTEM AND METHOD FOR VEHICLE

(71) Applicants: HYUNDAI MOTOR COMPANY, Seoul (KR); KIA MOTORS CORPORATION, Seoul (KR)

(72) Inventors: Sang Joon KIM, Seoul (KR); Jae Young PARK, Seongnam-si (KR); Hui Un SON, Suwon-si (KR); Young Eun KIM, Uiwang-si (KR); Jea Mun LEE, Seoul (KR); Sung Hoon YU, Hwaseong-si (KR)

(73) Assignees: HYUNDAI MOTOR COMPANY, Seoul (KR); KIA MOTORS CORPORATION, Seoul (KR)

(21) Appl. No.: 17/101,743

(22) Filed: Nov. 23, 2020

(30) Foreign Application Priority Data
Jul. 22, 2020 (KR) 10-2020-0091121

(51) Int. Cl. B60W 30/045; B60W 50/02; B60W 10/08; B60W 40/109; B60W 40/08

(52) U.S. Cl. CPC B60W 30/045; B60W 50/0205; B60W 10/08; B60W 40/109; B60W 40/08; B60W 2510/10; B60W 2510/18; B60W 2520/125; B60W 2540/10; B60W 2540/18; B60W 2510/20

(57) ABSTRACT

A turning control system for a vehicle having a driving motor to generate driving power may include: an error calculation unit that calculates an error between a lateral acceleration of the vehicle and a reference lateral acceleration; and a reduction torque calculation unit that calculates a torque reduction of the driving motor in order to reduce the error calculated by the error calculation unit.

### CROSS-REFERENCE TO RELATED APPLICATION

This application claims priority to and the benefit of Korean Patent Application No. 10-2020-0091121, filed on Jul. 22, 2020, the entire contents of which are incorporated herein by reference.

### FIELD

The present disclosure relates to a turning control system and method for a vehicle, and more particularly, to a turning control system and method for a vehicle, which can reduce under-steer of a vehicle, such that the vehicle can stably make a turn.

### BACKGROUND

The statements in this section merely provide background information related to the present disclosure and may not constitute prior art.

In general, when a vehicle makes a turn, for example, when a vehicle enters or exits from a ramp of a highway or turns left or right in a crossroad, the vehicle may be under-steered. In this case, the vehicle may be pushed out of a radius of turn, which is expected through a steering operation of the vehicle. In particular, when the velocity of the vehicle is high, the vehicle may be further under-steered.

In order to prevent such under-steer, various methods such as a torque vectoring method may be applied. According to the torque vectoring method, torque may be differently controlled for each wheel such that the vehicle can maintain on-center steering. According to another method, the vehicle may be automatically controlled to be decelerated when starting to turn.

In the conventional torque vectoring method, however, application responsiveness of a friction brake may be reduced, and a deceleration force may be generated to degrade driving feeling.

Furthermore, in the conventional control method which automatically performs deceleration control when an internal-combustion engine vehicle starts to turn, the internal-combustion engine vehicle is automatically controlled to be decelerated by an engine brake through CVT (Continuously Variable Transmission) control in a section where the vehicle starts to turn. The control method can be used only in a situation in which a driver sets a separate mode, and acceleration delay may occur when the vehicle is accelerated.

It should be noted that the contents described above as the related art are only examples for promoting understandings of the background of the present disclosure, and do not correspond to related arts which are already known to those skilled in the art to which the present disclosure pertains.

### SUMMARY

The present disclosure provides a turning control system and method for a vehicle, which can perform load transfer control of a vehicle by utilizing a driving motor, and thus increase a lateral force of a front wheel, thereby preventing under-steer.

Other objects and advantages of the present disclosure can be understood by the following description, and become apparent with reference to exemplary forms of the present disclosure. Also, it is obvious to those skilled in the art to which the present disclosure pertains that the objects and advantages of the present disclosure can be realized by the means as claimed and combinations thereof.

In accordance with one form of the present disclosure, there is provided a turning control system for a vehicle which has a driving motor to generate driving power. The vehicle turning control system may include: an error calculation unit configured to calculate an error between a lateral acceleration of the vehicle and a reference lateral acceleration; and a reduction torque calculation unit configured to calculate a torque reduction of the driving motor in order to reduce the error calculated by the error calculation unit.

The turning control system may further include a turning determination unit configured to determine whether to perform turning control for the vehicle, based on a steering angle and velocity of the vehicle.

The turning determination unit may determine to perform the vehicle turning control, when a steering angle of the vehicle falls within a preset reference steering angle range and the velocity of the vehicle is equal to or greater than a preset reference vehicle velocity.

The turning determination unit may determine not to perform the vehicle turning control, when the vehicle is being braked, an ABS or TCS installed in the vehicle is enabled, or the gears of the vehicle are being shifted.

The error calculation unit may calculate the error by comparing the lateral acceleration detected by a lateral acceleration sensor installed in a vehicle and the reference lateral acceleration derived by the following equation:

$${α}_{y \_ ref} = \frac{{V}^{2}}{L + {K}_{ref} {V}^{2}} δ$$

where a_{y_ref} represents the reference lateral acceleration, V represents the velocity of the vehicle, L represents the wheel base of the vehicle, δ represents the steering angle of the vehicle, and K_{ref} represents a predetermined constant number.

The error calculation unit may calculate the lateral acceleration using the following equation:

$${\hat{α}}_{y} = \frac{{V}^{2}}{L + {K}_{veh} {V}^{2}} δ$$

where \hat{α}_{y} represents the lateral acceleration, V represents the velocity of the vehicle, L represents the wheel base of the vehicle, and δ represents the steering angle of the vehicle,

wherein the error calculation unit may calculate the error by comparing the calculated lateral acceleration and the reference lateral acceleration derived by the following equation:

$${α}_{y \_ ref} = \frac{{V}^{2}}{L + {K}_{ref} {V}^{2}} δ$$

where a_{y_ref} represents the reference lateral acceleration, V represents the velocity of the vehicle, L represents the wheel base of the vehicle, δ represents the steering angle of the vehicle, and K_{ref} represents a predetermined constant number.

The reduction torque calculation unit may include a controller configured to derive the torque reduction for reducing the error.

The reduction torque calculation unit may further include a limiter configured to set the magnitude of the error to substantially zero (0), when the magnitude of the error is smaller than a preset reference value.

The reduction torque calculation unit may further include a limiter configured to limit the rate of change in torque reduction in order to prevent a rapid change in magnitude of the torque reduction derived by the controller.

The reduction torque calculation unit may further include: a duty setting unit configured to set a duty for dividing and outputting the torque reduction, derived by the controller, at predetermined time intervals; and a switching unit configured to output/block the torque reduction according to the duty set by the duty setting unit.

In accordance with another form of the present disclosure, there is provided a turning control method for a vehicle which has a driving motor configured to generate driving power. The turning control method may include: calculating an error between lateral acceleration of the vehicle and reference lateral acceleration; and calculating a torque reduction of the driving motor in order to reduce the calculated error.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block configuration diagram illustrating a turning control system for a vehicle in one form of the present disclosure;

FIG. 2 is a diagram illustrating a reduction torque calculation unit of the turning control system for a vehicle in another form of the present disclosure in more detail;

FIG. 3 is a flowchart illustrating a turning control method for a vehicle in one form of the present disclosure;

FIG. 4 is a graph illustrating a technique for applying torque reduction in the turning control method for a vehicle in one form of the present disclosure; and

FIG. 5 is a diagram illustrating a steering input, an error and a torque control state, when the turning control system and method for a vehicle in one form the forms of the present disclosure are applied.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereafter, a turning control system and method for a vehicle in accordance with exemplary forms of the present disclosure will be described in detail with reference to the accompanying drawings.

As publicly known in the art, some of exemplary forms may be illustrated in the accompanying drawings from the viewpoint of function blocks, units and/or modules. Those skilled in the art will understood that such blocks, units and/or modules are physically implemented by electronic (or optical) circuits such as logic circuits, discrete components, processors, hard wired circuits, memory devices and wiring connections. When the blocks, units and or modules are implemented by processors or other similar hardware, the blocks, units and modules may be programmed and controlled through software (for example, codes) in order to perform various functions discussed in the present disclosure. Furthermore, each of the blocks, units and/or modules may be implemented by dedicated hardware or a combination of dedicated hardware for performing some functions and a processor for performing another function (for example, one or more programmed processors and related circuits).

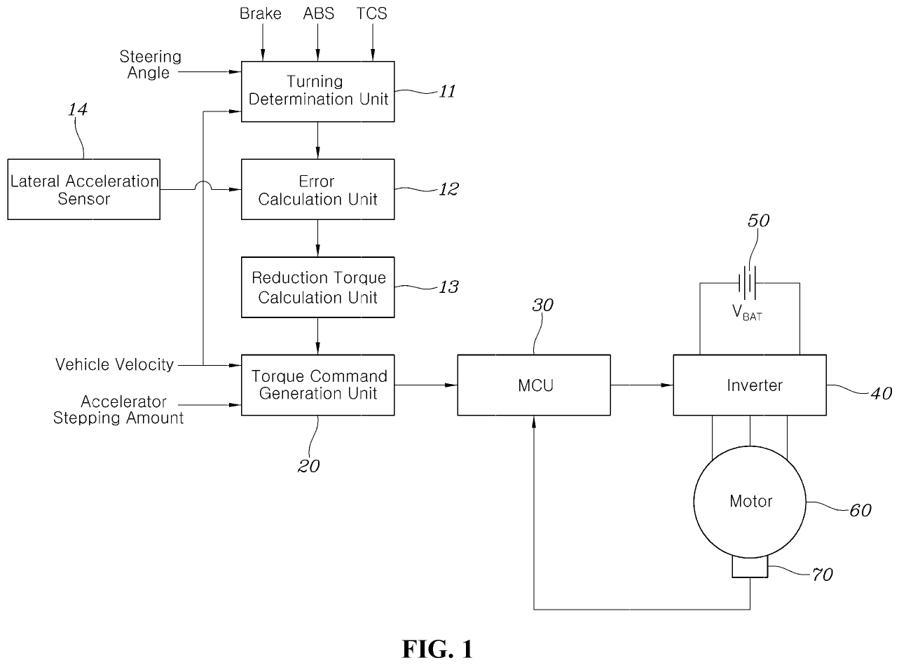

FIG. 1 is a block configuration diagram illustrating a turning control system for a vehicle in one form of the present disclosure.

Referring to FIG. 1, the turning control system for a vehicle may include a turning determination unit 11, an error calculation unit 12 and a reduction torque calculation unit 13. The turning determination unit 11 determines whether to perform vehicle turning control based on a steering angle and velocity of the vehicle. When the turning determination unit 11 determines to perform turning control, the error calculation unit 12 calculates an error between lateral acceleration of the vehicle and preset reference lateral acceleration. The reduction torque calculation unit 13 calculates a torque reduction of a driving motor 60 which generates driving power of the vehicle, in order to reduce the error calculated by the error calculation unit 12.

The turning determination unit 11 may receive the steering angle and velocity of the vehicle from a steering angle sensor (not illustrated) and a vehicle velocity sensor (not illustrated), which are installed in the vehicle, and determine whether to perform turning control based on the received values.

For example, when the steering angle of the vehicle falls within a preset reference steering angle range and the vehicle velocity is equal to or higher than the preset reference vehicle velocity, the turning determination unit 11 may determine to perform turning control in order to prevent under-steer such that the vehicle can stably make a turn.

When the steering angle is smaller than the minimum value of the reference steering angle range, the turning determination unit 11 may not determine that the vehicle is turned to the point where under-steer occurs. Thus, separate control for stable steering does not need to be performed. Furthermore, when the steering angle is larger than the maximum value of the reference steering angle range, the turning determination unit 11 may determine that the vehicle needs to be quickly turned by a driver. Thus, control for stable steering does not need to be performed. That is, the turning determination unit 11 may perform stable turning control in a section where a vehicle typically makes a turn, for example, when the vehicle travels on a ramp of a highway or makes a left or right turn in a crossroad.

When the vehicle velocity is lower than the reference vehicle velocity, the turning determination unit 11 may determine that the vehicle velocity does not correspond to a vehicle velocity at which the vehicle is under-steered. Thus, control for stable steering does not need to be performed.

The maximum and minimum values of the reference steering angle range and the reference vehicle velocity may be different for each vehicle, and experimentally decided in advance through a test drive of the vehicle.

In addition, the turning determination unit 11 may not perform turning control when the vehicle is placed in a specific critical situation. For example, when the vehicle is being braked by a brake operation of the driver, the turning determination unit 11 does not need to perform turning control for preventing under-steer. Furthermore, even when the ABS (Anti-lock Brake System) or TCS (Traction Control System) of the vehicle is enabled, the turning determination unit 11 does not need to perform turning control. The situation in which the ABS or TCS of the vehicle is operated may indicate that the vehicle is placed in an unstable state beyond a specific critical situation. Therefore, the situation in which the ABS or TCS of the vehicle is operated may be considered as a situation in which the turning determination unit 11 does not need to perform turning control for preventing under-steer.

When the turning determination unit 11 determines to perform turning control for preventing under-steer, the error calculation unit 12 may calculate an error between actual lateral acceleration of the vehicle during driving and the preset reference lateral acceleration.

The error calculation unit 12 may directly receive the lateral acceleration of the vehicle from a lateral acceleration sensor 14 installed in the vehicle.

For another example, the error calculation unit 12 may calculate the lateral acceleration of the vehicle, corresponding to the vehicle velocity and the steering angle, by utilizing a steady-state cornering equation of the vehicle.

Equation 1 below is a publicly known cornering equation.

$$δ = \frac{L}{R} + ( \frac{Mg}{{C}_{af} L} {l}_{r} - \frac{Mg}{{C}_{ar} L} {l}_{f} ) \frac{{V}^{2}}{gR} = \frac{L}{R} + K {α}_{y} \qquad [ Equation 1 ]$$

In Equation 1, δ represents a steering angle, L represents a wheel base indicating the distance between a front wheel and a rear wheel of the vehicle, R represents a radius of rotation when the vehicle makes a turn, M represents the weight of the vehicle, g represents gravitational acceleration, C_{αf} represents the stiffness of the front wheel of the vehicle, C_{αr} represents the stiffness of the rear wheel of the vehicle, if represents the distance from the front wheel of the vehicle to the center of gravity of the vehicle, and lr represents the distance from the rear wheel of the vehicle to the center of gravity of the vehicle.

In Equation 1, a term substituted with K is expressed as an under-steer gradient. When K is 0, the vehicle is neutrally steered. When K is larger than 0, the vehicle is under-steered. Furthermore, when K is smaller than 0, the vehicle is over-steered.

The lateral acceleration ay of the vehicle, which generates a centrifugal force which is applied in a direction perpendicular to the traveling direction of the turning vehicle, may be expressed Equation 2 below.

$${α}_{y} = \frac{{V}^{2}}{R} \qquad [ Equation 2 ]$$

When the left and right sides of Equations 1 and 2 are respectively simplified, the lateral acceleration of the vehicle may be expressed as Equation 3 below.

$${α}_{y} = \frac{{V}^{2}}{L + {KV}^{2}} δ \qquad [ Equation 3 ]$$

As expressed in Equation 3, the lateral acceleration of the vehicle may be expressed as the structural characteristic (wheel base) of the vehicle and the velocity V and the steering angle δ of the vehicle.

Using such a cornering equation of the vehicle, the error calculation unit 12 may calculate actual lateral acceleration of the vehicle as expressed as Equation 4 below.

$${\hat{α}}_{y} = \frac{{V}^{2}}{L + {K}_{veh} {V}^{2}} δ \qquad [ Equation 4 ]$$

In Equation 4, \hat{α}_{y} represents a value obtained by calculating the actual lateral acceleration of the vehicle. If necessary, the right side of Equation 4 may additionally have a term for compensating for delay which occurs while values (the vehicle velocity and the steering angle) actually measured by sensors (the vehicle velocity sensor and the steering angle sensor), which measure physical values for calculating the actual lateral acceleration, are received.

In Equation 4, Kᵥₑₕ represents an over-steer gradient during a steady state turn of the vehicle, which is experimentally decided in advance. For example, when the values measured by a vehicle velocity sensor, a lateral acceleration sensor and a steering angle sensor, which are installed in a test vehicle, are inputted to the steady-state cornering equation such as Equation 1 while the test vehicle is turned in a steady state, the value of Kᵥₑₕ during a steady state turn may be calculated in advance.

Furthermore, the error calculation unit 12 may calculate the reference lateral acceleration a_{y_ref} as expressed by Equation 5 below, based on the cornering equation of the vehicle.

$${α}_{y \_ ref} = \frac{{V}^{2}}{L + {K}_{ref} {V}^{2}} δ \qquad [ Equation 5 ]$$

In Equation 5, K_{ref} represents a constant having a preset value. When the vehicle intends to make a neutral turn, K_{ref} may be set to 0. Furthermore, K_{ref} may be set to a value slightly larger or smaller than 0 in advance, such that a driver can turn the vehicle most comfortably according to the characteristics of the vehicle.

The reduction torque calculation unit 13 may calculate reduction torque of the driving motor in order to reduce an error between the actual lateral acceleration of the vehicle and the reference lateral acceleration.

In the case of a vehicle which generates driving power from the driving motor, the torque of the driving motor is controlled. For example, a torque command generation unit 20 within a controller which is typically referred to as a VCU (Vehicle Control Unit) may generate a torque command based on the vehicle velocity and how much the driver steps on an accelerator pedal (accelerator pedal stepping amount), and provide the generated torque command to an MCU (Motor Control Unit) 30.

The MCU 30 generates a current command of the driving motor which can output torque corresponding to the provided torque command, compares the current command to an actually measured current provided to the driving motor, and controls a switching element within an inverter 40 to reduce a difference between the current command and the actually measured current.

The inverter 40 may include a plurality of switching elements which convert DC power stored in a battery 50 into AC power having a plurality of phases (typically, three phases), and provide the AC power to the driving motor 60. The MCU 30 may perform pulse width modulation control on the switching elements within the inverter 40, in order to provide the driving motor with a current corresponding to the current command.

The reduction torque calculation unit 13 may calculate the reduction torque for reducing the magnitude of the torque command provided to the MCU 30, and provide the calculated reduction torque to the torque command generation unit 20, and the torque command generation unit 20 may reduce torque by the calculated reduction torque, and provide the reduced torque to the MCU 30. By reducing the output of the driving motor 60 through such torque control, deceleration control may be performed. Thus, as a vertical force is added to the current of the vehicle (the load of the front wheel is increased), a lateral force for the front wheel of the vehicle is increased to reduce under-steer.

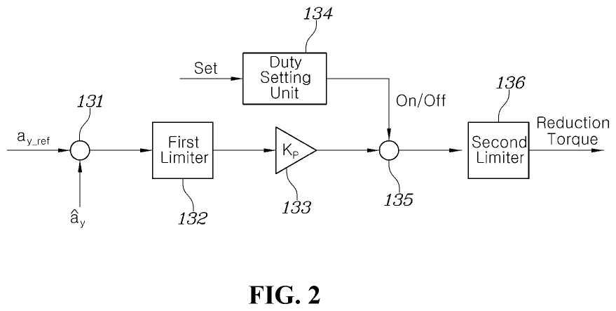

FIG. 2 is a diagram illustrating the reduction torque calculation unit of the turning control system for a vehicle in one form of the present disclosure in more detail.

Referring to FIG. 2, the reduction torque calculation unit 13 may include a controller 133 configured to derive reduction torque for reducing an error calculated by a subtractor 131 which calculates an error between actual lateral acceleration \hat{α}_{y} of the vehicle and the reference lateral acceleration a_{y_ref}. The subtractor 131 may be provided in the error calculation unit 12.

As the controller 133, a proportional controller, a proportional integration controller or a proportional integration differentiation controller, which is publicly known, may be selectively applied.

In one form, the reduction torque calculation unit 13 may further include a first limiter 132 which sets an error to 0, when the magnitude of the error is not so large or when the magnitude of the error is smaller than a preset reference value, in consideration of control sensitivity.

In another form, the reduction torque calculation unit 13 may further include a second limiter 136 for limiting the rate of change in reduction torque, in order to prevent a rapid change in magnitude of the reduction torque.

In other form, the reduction torque calculation unit 13 may further include a duty setting unit 134 and a switching unit 135. The duty setting unit 134 may set a duty for dividing and applying the reduction torque at predetermined time intervals, in order to prevent the driver from having excessive deceleration feeling while the torque is continuously reduced, and the switching unit 135 may output/block the reduction torque calculated by the controller 133 according to the duty set by the duty setting unit 134.

As described above, the turning control system for a vehicle, including the turning determination unit 11, the error calculation unit 12 and the reduction torque calculation unit 13, may be implemented in the form of an algorithm which implements the functions of the respective units within the controller.

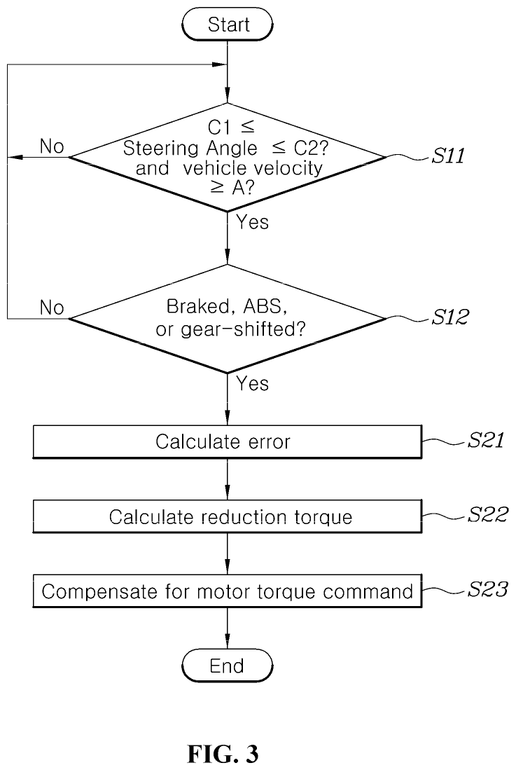

FIG. 3 is a flowchart illustrating a turning control method for a vehicle in another form of the present disclosure.

Referring to FIG. 3, the turning control method for a vehicle may start with steps S11 and S12 in which the turning determination unit 11 determines whether to perform turning control for preventing under-steer.

The turning determination unit 11 may determine whether a steering angle of the vehicle falls within a reference steering angle range having the preset minimum and maximum values C1 and C2, and determine whether the velocity of the vehicle is equal to or higher than a preset reference vehicle velocity A, in step S11.

When the steering angle is smaller than the minimum value C1, the turning determination unit 11 may not determine that the vehicle is turned to the point where the vehicle is under-steered, and does not need to perform separate control for stable steering. Furthermore, when the steering angle is larger than the maximum value C2, the turning determination unit 11 may determine that the vehicle needs to be quickly turned by the driver, and thus does not need to perform control for stable steering. When the vehicle velocity is smaller than the reference vehicle velocity A, the turning determination unit 11 may determine that the vehicle velocity does not correspond to a vehicle velocity at which the vehicle is under-steered, and does not need to perform control for stable steering.

In addition, the turning determination unit 11 may determine whether a driver is stepping on the brake pedal of the vehicle in order to brake the vehicle, or whether the ABS or TCS is enabled or the gears of the vehicle are being shifted, in step S12. The braking of the vehicle, the enabling of the ABS or TCS, and the changing of the vehicle velocity may correspond to a critical situation in which the vehicle needs to be controlled for the safety of the vehicle rather than the turning control for preventing under-steer of the vehicle. In this case, the turning control may not be performed.

Then, when the turning determination unit 11 determines to perform turning control for preventing under-steer, the error calculation unit 12 may calculate an error between actual lateral acceleration of the vehicle during driving and the preset reference lateral acceleration of the vehicle, in step S21.

As described above in the detailed descriptions for the error calculation unit 12, the error calculation unit 12 may directly receive the lateral acceleration of the vehicle from the lateral acceleration sensor 14 installed in the vehicle, or calculate the lateral acceleration of the vehicle corresponding to the vehicle velocity and the steering angle by utilizing the steady-state cornering equation of the vehicle, in step S21.

Furthermore, in step S21, the error calculation unit 12 may calculate the reference lateral acceleration a_{y_ref} using Equation 4 which is derived based on the steady-state cornering equation of the vehicle.

In step S21, the error calculation unit 12 may derive an error between actual lateral acceleration of the vehicle (a value detected by the sensor or a calculated value) and the reference lateral acceleration, through the subtractor.

Then, the reduction torque calculation unit 13 may calculate a torque reduction (reduction torque) of the driving motor in order to set the error to substantially 0 by reducing the error, in step S22.

In step S22, the reduction torque calculation unit 13 may calculate the torque reduction to reduce the error, using the typical controller 133 such as a proportional controller, a proportional integration controller or a proportional integration differentiation controller.

In one form, in step S22, the reduction torque calculation unit 13 may apply a limiter to set the magnitude of the error to substantially 0, when the magnitude of the error is smaller than the preset reference value, thereby reducing control sensitivity.

In another form, in step S22, the reduction torque calculation unit 13 may apply another limiter to limit the rate of change in torque reduction, in order to prevent a rapid change in the calculated torque reduction.

In other form, in step S22, the reduction torque calculation unit 13 may set a predetermined duty, such that the torque reduction is intermittently outputted at predetermined time intervals according to the set duty.

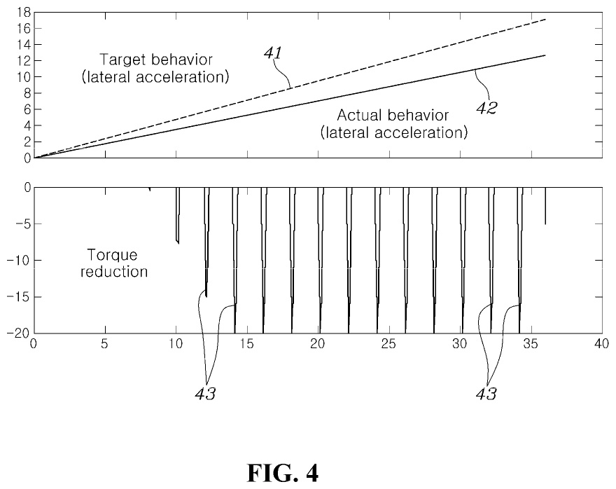

FIG. 4 is a graph illustrating a technique for applying torque reduction in the turning control method for a vehicle in other form of the present disclosure.

As illustrated in FIG. 4, when the magnitude of an error between the reference lateral acceleration (target behavior) 41 and actual lateral acceleration (actual behavior) 42 of the vehicle is equal to or higher than a predetermined level, control for reducing the torque command of the driving motor may be performed. At this time, an actual torque reduction 43 may not be applied as a constant value for a predetermined time, but intermittently applied at predetermined time intervals as illustrated in FIG. 4. That is, the torque reduction calculated by the reduction torque calculation unit 13 may be not constantly provided to the torque command generation unit 20 during a predetermined time interval, but intermittently provided according to a duty.

Such an operation can prevent the driver from having deceleration feeling while the torque is continuously reduced, thereby preventing the driver from having a sense of difference.

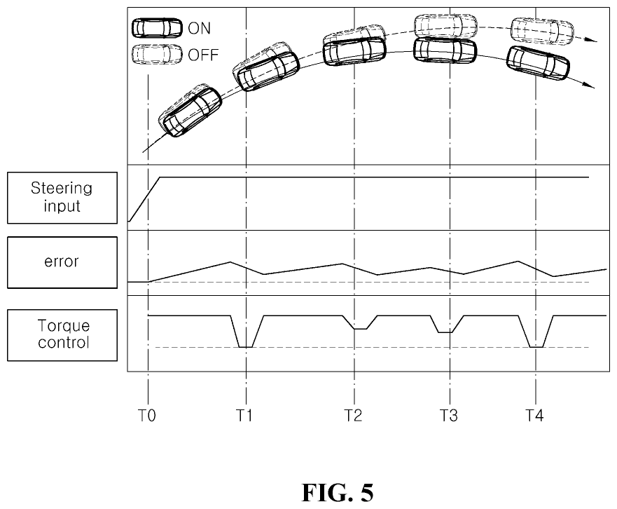

FIG. 5 is a diagram illustrating a steering input, an error and a torque control state, when the turning control system and method for a vehicle in some forms of the present disclosure are applied.

In FIG. 5, a path represented by ON indicates the case in which the turning control system for a vehicle in accordance with various forms of the present disclosure is operated or the turning control method for a vehicle is applied, and a path represented by OFF indicates the case in which turning control is not performed.

Referring to FIG. 5, when a steering input becomes equal to or more than a predetermined level under the supposition that the vehicle velocity is equal to or higher than the reference vehicle velocity, the steering control for preventing under-steer may be performed (time point T0). When an error becomes equal to or higher than a predetermined level, torque reduction control may be performed (time point T1). The torque reduction control may be performed at predetermined time intervals (time points T2, T3 and T4). When the turning control method for a vehicle in the form of the present disclosure is applied, an error may be limited to a predetermined value or less through the torque reduction control. Then, the vehicle may be stably turned while under-steer is reduced.

In the turning control system and method for a vehicle in accordance with the form of the present disclosure, a front wheel load of the vehicle may be increased while the vehicle velocity is reduced through the torque reduction control when the vehicle is turned. Thus, a lateral force of the front wheel of the vehicle may be increased to reduce under-steer of the vehicle.

In accordance with the exemplary forms of the present disclosure, the turning control system and method for a vehicle can reduce the torque of the diving motor of the vehicle in a section where the vehicle is turned, and perform control to transfer a load to the front wheel of the vehicle, thereby preventing under-steer of the vehicle. Furthermore, the turning control system and method for a vehicle can change the turning characteristics of the vehicle, thereby improving handling performance.

While the present disclosure has been described with respect to the exemplary forms, it will be apparent to those skilled in the art that various changes and modifications may be made without departing from the spirit and scope of the present disclosure.

What is claimed is:

1. A turning control system for a vehicle having a driving motor to generate driving power, the turning control system comprising:
an error calculation unit configured to calculate an error between a lateral acceleration of the vehicle and a reference lateral acceleration; and
a reduction torque calculation unit configured to calculate a torque reduction of the driving motor to reduce the error calculated by the error calculation unit.

2. The turning control system of claim 1, further comprising a turning determination unit configured to determine whether to perform a turning control for the vehicle, based on a steering angle and a velocity of the vehicle.

3. The turning control system of claim 2, wherein when a steering angle of the vehicle falls within a preset reference steering angle range and the velocity of the vehicle is equal to or greater than a preset reference vehicle velocity, the turning determination unit determines to perform the turning control.

4. The turning control system of claim 2, wherein when the vehicle is being braked, an Anti-lock Brake System (ABS) or a Traction Control System (TCS) installed in the vehicle is enabled, or gears of the vehicle are being shifted, the turning determination unit determines not to perform the turning control.

5. The turning control system of claim 1, wherein the error calculation unit is configured to calculate the error by comparing the lateral acceleration detected by a lateral acceleration sensor installed in the vehicle and the reference lateral acceleration derived by the following equation:
$${α}_{y \_ ref} = \frac{{V}^{2}}{L + {K}_{ref} {V}^{2}} δ$$
where a_{y_ref} represents the reference lateral acceleration, V represents a velocity of the vehicle, L represents a wheel base of the vehicle, δ represents a steering angle of the vehicle, and K_{ref} represents a predetermined constant number.

6. The turning control system of claim 1, wherein the error calculation unit is configured to calculate the lateral acceleration using the following equation:
$${\hat{α}}_{y} = \frac{{V}^{2}}{L + {K}_{veh} {V}^{2}} δ$$
where \hat{α}_{y} represents the lateral acceleration, V represents a velocity of the vehicle, L represents a wheel base of the vehicle, and δ represents a steering angle of the vehicle,
wherein the error calculation unit is configured to calculate the error by comparing the calculated lateral acceleration and the reference lateral acceleration derived by the following equation:
$${α}_{y \_ ref} = \frac{{V}^{2}}{L + {K}_{ref} {V}^{2}} δ$$
where a_{y_ref} represents the reference lateral acceleration, V represents the velocity of the vehicle, L represents the wheel base of the vehicle, δ represents the steering angle of the vehicle, and K_{ref} represents a predetermined constant number.

7. The turning control system of claim 1, wherein the reduction torque calculation unit comprises a controller configured to calculate the torque reduction for reducing the error.

8. The turning control system of claim 7, wherein the reduction torque calculation unit further comprises a limiter configured to set a magnitude of the error to substantially zero (0), when the magnitude of the error is smaller than a preset reference value.

9. The turning control system of claim 7, wherein the reduction torque calculation unit further comprises a limiter configured to limit a rate of change in the torque reduction to prevent a rapid change in a magnitude of the torque reduction calculated by the controller.

10. The turning control system of claim 7, wherein the reduction torque calculation unit further comprises:
a duty setting unit configured to set a duty for dividing and outputting the torque reduction, calculated by the controller, at predetermined time intervals; and
a switching unit configured to output or block the torque reduction based on the duty set by the duty setting unit.

11. A turning control method for a vehicle having a driving motor configured to generate driving power, the turning control method comprising:
calculating, by an error calculation unit, an error between a lateral acceleration of the vehicle and a reference lateral acceleration; and
calculating, by a reduction torque calculation unit, a torque reduction of the driving motor to reduce the calculated error.

12. The turning control method of claim 11, further comprising: determining, by a turning determination unit, whether to perform a turning control for the vehicle, based on a steering angle and a velocity of the vehicle.

13. The turning control method of claim 12, wherein determining whether to perform the turning control comprises: when the steering angle of the vehicle falls within a preset reference steering angle range and the velocity of the vehicle is equal to or greater than a preset reference velocity, determining to perform the vehicle turning control.

14. The turning control method of claim 12, wherein determining whether to perform the turning control comprises: when the vehicle is being braked, an Anti-lock Brake System (ABS) or a Traction Control System (TCS) installed in the vehicle is enabled, determining not to perform the vehicle turning control.

15. The turning control method of claim 11, wherein calculating the error comprises: calculating the error by comparing the lateral acceleration detected by a lateral acceleration sensor installed in the vehicle and the reference lateral acceleration derived by the following equation:
$${α}_{y \_ ref} = \frac{{V}^{2}}{L + {K}_{ref} {V}^{2}} δ$$
where a_{y_ref} represents the reference lateral acceleration, V represents a velocity of the vehicle, L represents a wheel base of the vehicle, δ represents a steering angle of the vehicle, and K_{ref} represents a predetermined constant number.

16. The turning control method of claim 11, wherein calculating the error comprises:
calculating the lateral acceleration using the following equation:
$${\hat{α}}_{y} = \frac{{V}^{2}}{L + {K}_{veh} {V}^{2}} δ$$
where \hat{α}_{y} represents the lateral acceleration, V represents a velocity of the vehicle, L represents a wheel base of the vehicle, and δ represents a steering angle of the vehicle; and
calculating the error by comparing the calculated lateral acceleration and the reference lateral acceleration derived by the following equation:
$${α}_{y \_ ref} = \frac{{V}^{2}}{L + {K}_{ref} {V}^{2}} δ$$
where a_{y_ref} represents the reference lateral acceleration, V represents the velocity of the vehicle, L represents the wheel base of the vehicle, δ represents the steering angle of the vehicle, and K_{ref} represents a predetermined constant number.

17. The turning control method of claim 11, wherein calculating the torque reduction comprises: setting a magnitude of the error to substantially zero (0), when the magnitude of the error is smaller than a preset reference value.

18. The turning control method of claim 11, wherein calculating the torque reduction comprises: limiting a rate of change in the torque reduction to prevent a rapid change in a magnitude of the torque reduction.

19. The turning control method of claim 11, wherein calculating the torque reduction comprises: dividing and outputting the torque reduction at predetermined time intervals.

20. The turning control method of claim 11, further comprising: controlling an output of the driving motor by decreasing the torque reduction from a torque command for the driving motor, the torque command being previously calculated based on a velocity of the vehicle and an accelerator pedal stepping amount of the vehicle.
